(19) United States
(12) Patent Application Publication
(10) Pub. No.: US 2021/0074959 A1
(43) Pub. Date: Mar. 11, 2021

(54) FLEXIBLE DEVICE METHODS AND APPARATUS

(71) Applicant: Immersion Corporation, San Jose, CA (US)

(72) Inventors: Vahid KHOSHKAVA, Montreal (CA); Peyman KARIMI ESKANDARY, Montreal (CA)

(21) Appl. No.: 16/562,910

(22) Filed: Sep. 6, 2019

(51) Int. Cl. H01M 2/02; H01M 6/04; H01M 6/14

(52) U.S. Cl. CPC H01M 2/0275; H01M 6/14; H01M 6/04

(57) ABSTRACT

In aspects, flexible device methods and apparatus are provided. For example, a flexible battery component providing multiple functions is provided. The flexible battery component includes an anode, a cathode, an electrolyte coupled to the cathode and the anode and configured to provide electrical power via the anode and the cathode, a container including the electrolyte and configured to be flexible and deformable, and at least one haptic component configured to provide a haptic effect, the least one haptic component being included in at least one of the electrolyte or the container. Numerous other aspects are provided.

### FIELD OF THE INVENTION

The present invention is directed to flexible device methods and apparatus, for example, a flexible battery component with multiple functions such as providing a haptic effect.

### BACKGROUND

Battery technology has been under constant development, especially as mobile devices have become more and more common. With the advancement of battery technology, a battery may be made in various shapes and sizes. For example, a battery may be made in a thin layer or a thick block and/or can be made in liquid form, a solid form, and a semi-solid form. Recently, batteries that are flexible have been under development, as flexibility in a battery may provide advantages in certain applications. Hence, structures for and uses of a flexible battery may be further improved.

### SUMMARY

One aspect of embodiments hereof relates to a flexible battery component providing multiple functions. The flexible battery component may include an anode, a cathode, and an electrolyte coupled to the cathode and the anode and configured to provide electrical power via the anode and the cathode. The flexible battery component may also include a container including the electrolyte and configured to be flexible and deformable. The flexible battery component may further include at least one haptic component configured to provide a haptic effect, the at least one haptic component being included in at least one of the electrolyte or the container.

One aspect of embodiments hereof relates to a flexible device including a flexible battery component for providing multiple functions and a device component including at least one processor coupled to and powered by the flexible battery component. The flexible battery component may include an anode, a cathode, and an electrolyte coupled to the cathode and the anode and configured to provide electrical power via the anode and the cathode. The flexible battery component may also include a container including the electrolyte and configured to be flexible and deformable. The flexible battery component may further include at least one haptic component configured to provide a haptic effect, the at least one haptic component being included in at least one of the electrolyte or the container. Numerous other aspects are provided.

### BRIEF DESCRIPTION OF THE DRAWINGS

The foregoing and other features, objects and advantages of the invention will be apparent from the following description of embodiments hereof as illustrated in the accompanying drawings. The accompanying drawings, which are incorporated hereof and form a part of the specification, further serve to explain the principles of the invention and to enable a person skilled in the pertinent art to make and use the invention. The drawings are not to scale.

FIG. 1A illustrates a block diagram of a flexible battery component with multiple functions, according to an embodiment hereof.

FIG. 1B illustrates a block diagram of a flexible device including a device component and the flexible battery component of FIG. 1A, according to an embodiment hereof.

FIG. 2A is a perspective view of a flexible battery component, according to an embodiment hereof.

FIGS. 2B-2D illustrate alternate sectional views of the flexible battery component of FIG. 2A taken along line X-X, according to various embodiments hereof.

FIGS. 3A, 3B, 3C and 3D illustrate a flexible device including a flexible battery component and a device component configured to couple with the flexible battery component, according to an embodiment hereof.

FIGS. 4A and 4B illustrate a flexible battery component providing a haptic effect, according to an embodiment hereof.

FIGS. 5A and 5B illustrate a flexible battery component including haptic components having haptic areas and a device component including user interaction components, according to an embodiment hereof.

FIG. 5C is a cross-sectional view taken along line E-E of FIG. 5B that illustrates the flexible battery component of FIG. 5B coupled to the device component of FIG. 5B, according to an embodiment hereof, where the haptic components are not activated.

FIG. 5D is a cross-sectional view taken along line E-E of FIG. 5B that illustrates the flexible battery component of FIG. 5B coupled to the device component of FIG. 5B, according to an embodiment hereof, where one of the haptic components is activated.

FIG. 6A illustrates a flexible battery component having a container that includes multiple compartments that include an electrolyte, according to an embodiment hereof.

FIG. 6B illustrates the flexible battery component of FIG. 6A undergoing deformation as a haptic effect, according to an embodiment hereof.

FIG. 7 depicts a sectional view of a flexible battery component with a container having multiple compartments, according to an embodiment hereof.

FIG. 8 depicts a sectional view of another flexible battery component with a container having multiple compartments, according to an embodiment hereof.

FIG. 9A depicts a flexible battery component having a structure that directs heat dissipation to a particular direction, according to an embodiment hereof.

FIGS. 9B and 9C are respective sectional views of the flexible battery component of FIG. 9A along line F-F of FIG. 9A, according to various embodiments hereof.

FIG. 9D depicts heat dissipation of the flexible battery component of FIG. 9A during deformation of the flexible battery component, according to an embodiment hereof.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

In aspects, embodiments described herein relate to a flexible device. In aspects embodiments described herein relate to a flexible battery component that may provide haptic feedback. More particularly, a flexible battery component in accordance herewith may be designed such that the flexible battery component provides multiple functions or one or more functions in addition to providing power. The flexible battery component may be coupled to a device to provide power to the device and haptic feedback associated with the device, and may additionally provide additional functions associated with the device. A flexible battery component with multiple functions in accordance with embodiments described herein may be advantageous in that the functions that are conventionally provided by another device may be provided by the flexible battery component.

Some devices may be designed to have simple structures and/or limited functionalities. For example, a device may have a simple structure (e.g., without a housing) that includes a layer of a flexible device that may couple with a layer of a flexible battery component with multiple functions. By providing a flexible battery component with multiple functions in accordance with embodiments described herein, a device having a simple structure and/or limited functions may be coupled with the flexible battery component having multiple functions to rely on the function(s) provided by the flexible battery component. For example, a simple device having no haptic capability may be coupled with a flexible battery component that provides haptic feedback, such that the simple device may then provide haptic feedback using the flexible battery component's haptic capability.

More particularly, in an aspect, some embodiments described herein relate to a flexible battery component providing multiple functions, such as a battery power feature, haptic feedback capabilities, power-harvesting capabilities, etc. The flexible battery component includes an anode, a cathode, an electrolyte coupled to the cathode and the anode and configured to provide electrical power via the anode and the cathode. The electrolyte may include at least one of a liquid electrolyte, a semi-solid electrolyte (e.g., gel), or a solid electrolyte. The flexible battery component further includes a container including the electrolyte (e.g., to safely contain the electrolyte and to prevent contact with a human), where the container is configured to be flexible and deformable. In an embodiment, a container may include a single compartment or multiple compartments to include the electrolyte. If the container includes multiple compartments, the electrolyte may be included in one or more (e.g., each) of the multiple compartments. For example, a container may include multiple pouches, where each pouch includes the electrolyte.

In accordance with embodiments described herein, a flexible battery component may also include at least one haptic component configured to provide haptic feedback (e.g., a haptic effect). In embodiments described herein, a haptic component may be included in at least one of an electrolyte or a container of a flexible battery component. In one example, when a processor residing within a flexible battery component or outside of a flexible battery component determines to provide a haptic effect, the processor may cause a haptic component to provide the haptic effect. In one example, the haptic effect may be based on deformation of the haptic component, where the deformation of the haptic component may also cause deformation of one or more portions of the flexible battery component. For example, if a container is made flexible and deformable, the container may deform along with the deformation of the haptic component.

In an embodiment, a haptic component may be configured to provide haptic feedback or a haptic effect based on a trigger that includes at least one of an electrical signal, an electric field, a magnetic field, a lighting condition, a pH level, or a temperature. For example, a haptic component may be configured to deform to provide haptic feedback or a haptic effect when one or more of the electrical signal, the electric field, the magnetic field, light, an environment with a particular pH level, and a particular temperature occurs. In an example, a processor residing within the flexible battery component or outside of the flexible battery component may determine whether to provide the trigger for providing the haptic effect. If the processor determines to provide a haptic effect, the processor may provide the trigger or cause one or more components to provide the trigger to cause the haptic component to provide the haptic effect.

In an embodiment, a haptic component may include one or more haptic components located in one or more haptic areas of the flexible battery component, respectively. As such, haptic feedback may be provided at a specific haptic area of a flexible battery component that corresponds to a particular haptic component. In such an embodiment, the one or more haptic areas may respectively correspond to one or more user interaction components on another component configured to be coupled with the flexible battery component. As such, a user interacting with a particular user interaction component may be able to perceive a haptic effect in a corresponding haptic area provided by a corresponding haptic component.

In an embodiment, a haptic component may be configured to provide a haptic effect based on deformation. For example, the haptic component may be formed of a shape memory material, e.g., a polymer or a metal that after processing may be made to provide a shape memory to the haptic component. The haptic component of a shape memory material may undergo a change in shape or dimension upon application of at least one of a trigger, a stimulus, or a change in a surrounding environment. In such an embodiment, the change in the haptic component may be based on a trigger including at least one of an electrical signal, an electric field, a magnetic field, a lighting condition, a pH level, or a temperature.

In an embodiment, a haptic component formed of a shape memory material may be coupled to at least a perimeter of the container.

In an embodiment, a haptic component formed of a shape memory material may further include magnetically-activated particles configured to generate heat when a magnetic field is applied to the magnetically-activated particles, where the haptic component of the shape memory material may be configured to change shape or otherwise deform (such as twist, wrinkle, bend, curl, etc.) based on the heat generated by the magnetically-activated particles, e.g., to provide haptic feedback via deformation. In an example, the magnetic field may be generated by a magnetic field generating device such as a solenoid when a processor determines to provide a haptic effect.

In an embodiment, the flexible battery component may further include a heat dissipation structure to provide a heat dissipation path (e.g., for a haptic component) in a direction perpendicular or substantially perpendicular to a planar surface of the flexible battery component. In such an embodiment, the heat dissipation structure may reduce or prevent heat dissipation in an in-plane direction of the planar surface. For example, for a flexible battery component with a substantially planar surface, the direction perpendicular to the planar surface of the flexible battery component may be an out-of-plane direction perpendicular to the substantially planar surface of the flexible battery component. As such, any unwanted deformation by heat may be reduced and/or minimized by efficient heat dissipation out of the flexible battery component via the heat dissipation path in the direction perpendicular to a planar surface of the flexible battery component while reducing and/or preventing heat dissipation in the in-plane direction.

In an embodiment, an electrolyte for use in embodiments described herein may include a haptic component. In an example, the haptic component may be included within the electrolyte and/or may include a haptic material mixed with the electrolyte. As such, for example, a haptic component configured to provide deformation haptic feedback may cause an electrolyte, and/or a container holding the electrolyte, to deform along with the deformation of the haptic component. In an example, the electrolyte may be a solid-state electrolyte (e.g., lithium electrolyte) having pores and/or cavities filled with the haptic material (e.g., plasticized polyvinyl chloride (PVC) gel).

In an embodiment, a haptic component may include a gel material configured to change viscosity based on a trigger including at least one of an electrical signal, magnetic field, a lighting condition, a pH level, or a temperature. For example, the gel material of the haptic component may become stiffer in the presence of the trigger, and may become less stiff in the absence of the trigger.

In an embodiment, a flexible battery component may further include at least one of a power-harvesting component configured to harvest power from an environment of the flexible battery component or a sensor. For example, a power-harvesting component for use in embodiments described herein may harvest power based on sunlight, temperatures, and/or deformation of one or more components of the flexible battery component. A sensor for us in embodiments described herein may be configured to sense events or changes in a surrounding environment.

In an embodiment, a flexible battery component may further include a processor configured to provide a haptic signal to a haptic component to provide a haptic effect based on the haptic signal. For example, the processor may be made of a flexible component such as a flexible thin-film transistor.

In an embodiment, a processor may be powered by electrical power derived from an electrolyte of a flexible battery component.

In an aspect, some embodiments described herein relate to a flexible device including a flexible battery component for providing multiple functions and a device component including at least one processor coupled to and powered by the flexible battery component. In an embodiment, the device component may further include a flexible display device coupled to and powered by the flexible battery component. The flexible battery component comprises an anode, a cathode, an electrolyte coupled to the cathode and the anode and configured to provide electrical power via the anode and the cathode, a container including the electrolyte and configured to be flexible and deformable, and at least one haptic component configured to provide a haptic effect, a haptic component being included in at least one of the electrolyte or the container. The flexible battery component may include some of all of the features discussed above.

In an example, a processor of the flexible device may determine whether to provide a haptic effect. If a processor determines to provide a haptic effect, the processor may cause a haptic component to provide the haptic effect. In one example, the haptic effect may be based on deformation of a haptic component, where the deformation of the haptic component may also cause deformation of one or more portions of the flexible device, including one or more portions of the flexible battery component and one or more portions of the device component coupled to the flexible battery component. In an embodiment wherein a container is also flexible and deformable, the container may deform along with the deformation of the haptic component. In an embodiment, the flexible battery component and the device component may be flexible and deformable, and thus may deform along with the deformation of the haptic component.

In an embodiment, a haptic component may include one or more haptic components located in one or more haptic areas of a flexible battery component, respectively, and a device component may include one or more user interaction components that respectively correspond with the one or more haptic areas. As such, a user interacting with a particular user interaction component of the device component may be able to perceive a haptic effect in a corresponding haptic area provided by a corresponding haptic component of the flexible battery component.

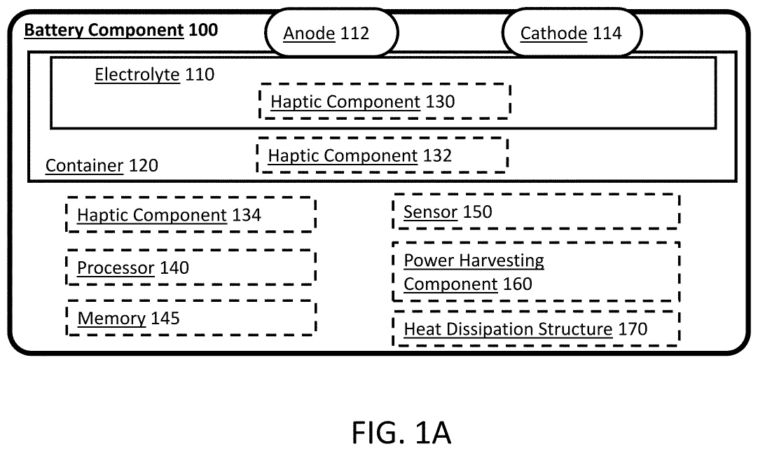

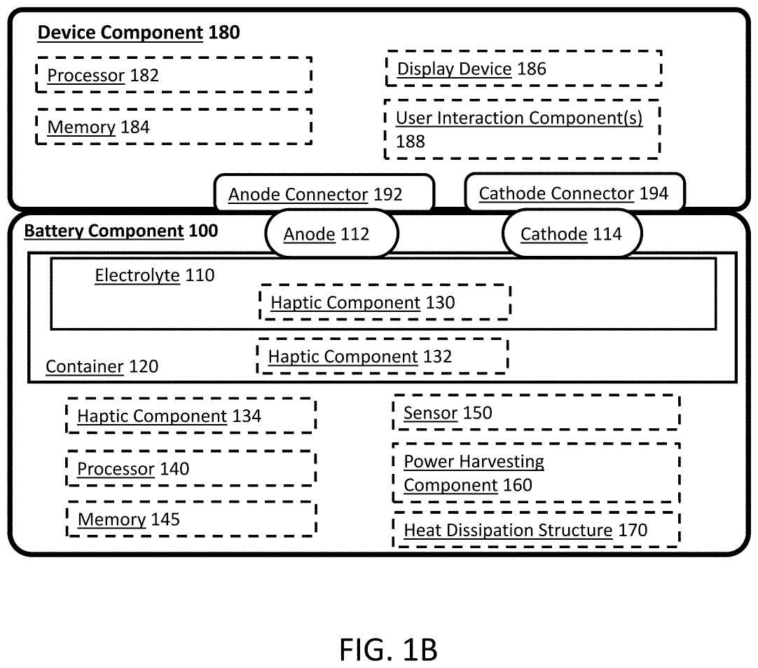

FIG. 1A illustrates a block diagram of a flexible battery component 100 with multiple functions, according to an embodiment described herein. The flexible battery component 100 includes an anode 112 and a cathode 114 and also includes an electrolyte 110 coupled to the anode 112 and the cathode 114. In one example, one or more of the anode 112 and the cathode 114 may be implemented as electrode materials printed or coated onto the flexible battery component 100, or may be implemented as electrodes protruding outward from the flexible battery component 100. The electrolyte 110 may be also referred to as an electrolytic cell. The electrolyte 110 undergoes a chemical reaction that converts chemical energy into electrical energy, which is battery power. For example, the chemical reaction of the electrolyte 110 may cause electrons within the electrolyte 110 to move to the cathode 114, resulting in an electrical potential difference between the anode 112 and the cathode 114. Hence, the electrolyte 110 is configured to provide electrical power via the anode 112 and the cathode 114, e.g., via the chemical reaction of the electrolyte 110. The cathode 114 may be considered a negative side, as the electrons move to the cathode 114 due to the chemical reaction, and the anode 112 may be considered a positive side.

The electrolyte 110 may include at least one of a solid electrolyte, semi-solid electrolyte (e.g., gel), or liquid electrolyte. For example, the semi-solid electrolyte may be a gel electrolyte having a liquid electrolyte in a flexible polymer lattice framework. In one example, a lithium-ion electrolyte may be formed as a solid-electrolyte, a semi-solid electrolyte, and the liquid electrolyte. In such an example, a lithium-ion electrolyte may be formed as a ceramic solid electrolyte where ions travel through ceramic, or a liquid lithium-ion electrolyte where the ions travel through the liquid, or a gel electrolyte made of the liquid lithium-ion electrolyte in a flexible polymer lattice framework.

In the flexible battery component 100, the electrolyte 110 is included (e.g., contained) in a container 120. In an aspect, the container 120 may be capable of containing the electrolyte 110 within the container 120 without exposing the electrolyte 110 to the outside of the container, e.g., so as to prevent a user from being in contact with the electrolyte 110. The container 120 may be flexible and deformable. As the container 120 is deformable, the container 120 is capable of changing a shape thereof, e.g., by bending and/or twisting and/or curling. For example, the container 120 may be made of flexible polymer(s) or a flexible metal structure such as a thin metal sheet, which allows the container 120 to change its shape, e.g., when force is applied or physical properties of the container 120 change. For example, the container 120 may be a flexible housing or a frame or may be a flexible pouch having one or more compartments to contain the electrolyte 110.

If the electrolyte 110 within the container 120 is flexible or can be deformed together with deformation of the container 120, the electrolyte 110 may be included in a single compartment or in multiple compartments. For example, if the electrolyte 110 includes one or more of a flexible solid electrolyte, a semi-solid electrolyte, and a liquid electrolyte, the electrolyte 110 may be included in a single compartment or in multiple compartments within the container 120. The semi-solid electrolyte and the liquid electrolyte may be deformable by nature. In an example, a certain type of solid electrolyte may become more flexible and more deformable as the thickness of the solid electrolyte becomes smaller. In such an example, if this type of solid electrolyte is made into a thin structure (e.g., thin sheet), the solid electrolyte may be a flexible solid electrolyte, while a solid electrolyte made into a thick structure may be an inflexible solid electrolyte. If the electrolyte 110 within the container 120 is not flexible or cannot be deformed together with deformation of the container 120, the electrolyte 110 may be included in multiple compartments of the container 120, where portions between the compartments of the container 120 may be flexible to be deformable. For example, an electrolyte 110 that is a solid inflexible electrolyte (e.g., ceramic solid electrolyte) may be contained in multiple compartments of the container 120 such that the container 120 may be deformable in portions between the compartments.

The flexible battery component 100 further includes a haptic component (e.g., a haptic component 130 and/or a haptic component 132 and/or a haptic component 134) configured to provide a haptic effect. The haptic component 130 and/or the haptic component 132 and/or the haptic component 134 may be configured to provide a haptic effect while allowing deformation of the container 120 and/or the electrolyte 110. In an aspect, the flexible battery component 100 may include the haptic component 130 that is included in the electrolyte 110. In one example, the haptic component 130 may include a haptic material mixed with the electrolyte 110 and/or disposed within the electrolyte 110 (e.g., within pores/cavities of the electrolyte 110), within the container 120. In an aspect, the flexible battery component 100 may include the haptic component 132 that is disposed within the container 120 and not included in the electrolyte. In one example, the haptic component 132 may be a part of the container 120 or the container 120 may be made of the haptic material of the haptic component 132. Providing a haptic component 132 as the container 120 or as a part of the container 120 may be advantageous in that the functions of the haptic component 132 and the container 120 may be provided within a single structure of the container 120. In an aspect, the flexible battery component 100 may include the haptic component 134 that is disposed outside the container 120. In one example, the haptic component 134 may be attached to the outer surface of the container 120. For example, the haptic component 134 may be coupled to a perimeter of the container 120.

In accordance with embodiments described herein, a shape memory material for forming a haptic component that undergoes a change in shape based on a trigger, such as an electrical signal, electric field, magnetic field, ultrasound, heat, force, pressure, etc., may include: a shape memory alloy, such as stainless steel; a pseudo-elastic metal, such as a nickel titanium alloy or nitinol; various polymers; or a so-called super alloy, which may have a base metal of nickel, cobalt, chromium, or other metal. For example, the shape memory material may include polymers such as polynorbornene, trans-polyisoprene, styrene-butadiene, and polyurethane that may be made into a shape memory polymer.

In an example, a haptic component made of a shape memory material may be pre-configured to a particular shape(s). For example, the haptic component made of the shape memory material that is pre-configured to a first shape may form a second, remembered, shape that is different from the first shape when the trigger that is intended to cause the change in shape is applied. In addition, the haptic component of the shape memory material may return to the first shape when the trigger is removed. The trigger may be an electrical signal, an electric field, a magnetic field, sound (e.g., ultrasound), a particular temperature, force, light, (e.g., ultraviolet light), pressure, etc.

In another embodiment, the haptic component may include a smart material actuator as a haptic actuator that provides haptic feedback. The smart material actuator may include a shape memory material and may be capable of providing tactile feedback based on a change of shape in the shape memory material. As discussed above, the change of shape in the shape memory material may be caused by the trigger, such as an electrical signal, an electric field, a magnetic field, sound (e.g., ultrasound), a particular temperature, force, light, (e.g., ultraviolet light), pressure, etc.

In one example, the haptic component formed of the shape memory material may undergo a change shape when heat is applied. To apply heat to such a shape-changing haptic component, one or more of various heat generation approaches may be used. In an example, the shape-changing haptic component may also include magnetic-activated particles that generate heat when exposed to a magnetic field. In such an example, to change the shape of the haptic component made of the shape memory material, a magnetic field may be applied so that the magnetic-activated particles may generate heat, which consequently causes the shape of the haptic component to change.

In an embodiment, the haptic component 130 and/or the haptic component 132 and/or the haptic component 134 may be made of a haptic material that is configured to undergo a change in a physical property and/or a chemical property as haptic feedback, where the change may take place based on a trigger such as an electrical signal, an electric field, a magnetic field, sound (e.g., ultrasound), a particular temperature, force, light, (e.g., ultraviolet light), pressure, etc. In such an embodiment, changes in the physical property and/or the chemical property of the haptic material of the haptic component may be perceived by a user as haptic feedback. The change in the physical property of the haptic material may include a change in in firmness or viscosity of the haptic material. The change in the chemical property of the haptic material may cause a change in viscosity and/or in temperature of the haptic material. For example. the haptic material may include at least one of a smart gel, or a smart fluid, where the smart gel or the smart fluid may undergo a change in property (e.g., viscosity) based on the trigger. In another embodiment, the haptic material may provide a change in temperature as a haptic effect. For example, the haptic component may include a thermoelectric device that may cool, or heat based on electricity applied to the thermoelectric device and the haptic material may be a thermoelectric material for the thermoelectric device.

In an example, a haptic material that is or forms a haptic component may include a smart gel that may expand or contract based on a trigger by a chemical stimulus or a physical stimulus. The chemical stimulus may include changing pH of the smart gel material. The physical stimulus may include at least one of a temperature change, light, an electric field, a magnetic field, or mechanical forces (e.g., shaking of the smart gel). In an example, a smart gel may be made of liquid in a matrix of polymers whose structures change based on the chemical stimulus and/or the physical stimulus.

In an example, the stiffness or the viscosity of a haptic material that is or forms a haptic component may be increased by cross-linking (e.g., via a chemical or a physical cross-link) polymer chains of the haptic material and may be reduced by removing the cross-linking of the polymer chains of the haptic material. For example, the haptic material may be made of microparticles whose orientations may be affected by an electric field or a magnetic field. The electric field or the magnetic field changes the orientations of the microparticles (e.g., by cross-linking the microparticles), which may cause the viscosity of the haptic material to increase. In one example, such a haptic material may be a silicon material containing iron or magnetic microparticles (e.g., with a diameter of 10 nm-5 um) that are in a dispersed phase in the absence of a magnetic field, where the iron or magnetic microparticles may be re-oriented (e.g., by cross-linking the microparticles) to increase the viscosity of the haptic material when the magnetic field is applied. In another example, the stiffness or the viscosity of a haptic material that is or forms a haptic component may be changed by heat or a change of pH of the material.

In an embodiment, a rate of change in viscosity/stiffness or a rate of deformation of the haptic component may be used as haptic feedback. In one example, the rate of change in viscosity or the rate of deformation of the haptic component may indicate a degree of a temperature. For example, for a higher temperature surrounding the haptic component, the haptic component may undergo a higher rate of change in the viscosity or a higher rate of deformation of the haptic effect.

In an embodiment, the stiffness or the viscosity of the haptic component may change due to a chemical change and/or a physical change in the haptic component. In an aspect, a haptic effect may be provided by the change in stiffness or the viscosity of the haptic component that is caused by a trigger. In an example, the haptic component may be made of PVC gel where an electric field may cause the material deformation of the PVC gel, which may be perceived as a change in stiffness. In another example, the haptic component may be made of sodium polyacrylate (pNaAc) where an ion printing technique may be used to change the chemical structure locally by imprinting ions (e.g., cupric ions) at a particular portion of the haptic component, such that the stiffness of the haptic component may change locally at the particular portion of the haptic component when electricity is applied to the imprinted ions.

In an embodiment, the flexible battery component 100 may include a processor 140 configured to perform various tasks. The processor 140 may be provided with the container 120, within the container 120, attached to the container 120, and/or may be provided separately from the container 120. In an aspect, the battery power from the electrolyte 110 may be provided to the processor 140 to provide power to the processor 140. The processor 140 may be configured to generate a control signal by executing instructions (e.g., stored in memory 145). The processor 140 may, in an embodiment, be implemented as one or more processors (e.g., a microprocessor), a field programmable gate array (FPGA), application specific integrated circuit (ASIC), programmable logic array (PLA), or other control circuit. The processor 140 may be part of a general purpose control circuit for the flexible battery component 100 or the processor 140 may be a processor dedicated to controlling haptic effects for the flexible battery component 100. In an aspect, the processor 140 may be a flexible processor, e.g., based on flexible thin-film transistor(s), such that the processor 140 may deform along with the battery component 100 when the haptic component causes the deformation.

In an embodiment, the flexible battery component 100 may include a memory 145, as a data storage component. The memory 145 may be a flexible memory. In an embodiment, the memory 145 may be a non-transitory computer-readable medium, and may include read-only memory (ROM), random access memory (RAM), a solid state drive (SSD), a hard drive, a flash memory, or other type of memory. In FIG. 1, the memory 145 may store instructions that can be executed by the processor 140 to generate a control signal, such as a trigger signal, as a trigger for the haptic feedback according to an embodiment described herein. In an embodiment, the memory 145 may store other information and/or modules.

In an embodiment, the flexible battery component 100 may include at least one sensor 150. The at least one sensor 150 may be configured to sense events or changes in a surrounding environment and send information about the surrounding environment to another device, such as the processor 140 and the memory 145. For example, the at least one sensor 150 may include at least one of a temperature sensor, a brightness sensor, a force sensor, etc. In one example, the at least one sensor 150 may be a part of one or more components of the flexible battery component 100, where the sensor 150 may sense deformation of the flexible battery component 100.

In an embodiment, the at least one sensor 150 may include a force sensor and/or a pressure sensor configured to sense pressure or force applied to the flexible battery component 100. In one example, the at least one sensor 150 may be sense pressure or force when the flexible battery component 100 is deformed.

In an embodiment, the flexible battery component 100 may include a power harvesting component 160. The power harvesting component 160 may be configured to harvest power for one or more components of the flexible battery component 100. For example, the power harvesting component 160 may harvest electrical power that may be stored in the electrolyte 110. The power harvesting component 160 may include at least one of a solar power component to generate power based on sunlight, a thermoelectric generator configured to generate power based on heat flux (e.g., temperature difference), a piezoelectric generator configured to generate power based on deformation of a piezoelectric material, etc.

In an embodiment where a structure is formed from a shape memory material that may change shape when heat is applied, the heat experienced by the structure may create unwanted deformation due to the shape memory characteristics thereof. For example, if the battery component 100 emits heat or other external heat that affects a haptic component formed of a shape memory material, the flexible battery component 100 may deform even in the absence of the trigger, which creates unwanted deformation. Further, excess heat within the flexible battery component 100 may have adverse effects on the flexible battery component 100. The flexible battery component 100 may be structured so as to reduce, minimize and/or eliminate the unwanted deformation by heat. In particular, the flexible battery component 100 may have a heat dissipation structure 170 that allows heat dissipation in a direction perpendicular, substantially perpendicular, or out-of-plane with respect to the planar surface of the flexible battery component 100 including the haptic component formed of the shape memory material while reducing and/or preventing heat dissipation path in in-plane directions of the flexible battery component 100. For example, a heat dissipation path of the heat experienced by the haptic component may exist in a direction perpendicular, substantially perpendicular, or out-of-plane with respect to the planar surface of the flexible battery component 100 including the haptic component formed of the shape memory material, while no or little heat dissipation path may exist in in-plane directions of the flexible battery component 100, to avoid adversely affecting shape memory characteristics of the haptic component of the flexible battery component 100. In an example, the heat dissipation structure 170 may allow heat dissipation in a direction perpendicular, substantially perpendicular, or out-of-plane with respect to a planar surface of the haptic component formed of the shape memory material while reducing and/or preventing heat dissipation path in in-plane directions of the haptic component. In an example, the heat dissipation structure 170 may allow heat dissipation in a direction perpendicular, substantially perpendicular, or out-of-plane with respect to a planar surface of the heat dissipation structure 170 while reducing and/or preventing heat dissipation path in in-plane directions of the heat dissipation structure 170, to reduce, prevent and/or minimize heat adversely affecting the haptic component formed of the shape memory material.

In an embodiment, the heat dissipation structure 170 may be made of a material with thermal conductivity and/or a structure for reducing. minimizing and/or eliminating the unwanted deformation by heat. The heat dissipation structure 170 may be included in the haptic component of the flexible battery component 100. In an example, the heat dissipation structure 170 may be made of a material with a thermal conductivity greater than 100 watts per meter-kelvin (W·m⁻¹K⁻¹), such as copper that has a thermal conductivity of 400 W·m⁻¹·K⁻¹. In an example, the thermal conductivity of the material for the heat dissipation structure 170 may range between 200 W·m⁻¹·K⁻¹ and 2000 W·m⁻¹·K⁻¹. For example, the heat dissipation structure 170 may include a heterogenous material in thermal heat conduction that is configured to conduct heat in one direction (e.g., in-plane direction) but not in another direction (e.g., perpendicular or out-of-plane direction). In one example, the heterogeneous material for the container may be a foam-type material or an aerogel material arranged such that there is little air within the heterogeneous material along a first direction (e.g., in-plane direction) to allow heat conduction while there is much air within the heterogeneous material along a second direction (e.g., perpendicular or out-of-plane direction) to prevent heat conduction in the second direction.

FIG. 1B illustrates a block diagram of a flexible device including a device component 180 and the flexible battery component 100, where the device component 180 may be coupled to the flexible battery component 100. The device component 180 includes an anode connector 192 and a cathode connector 194 configured to connect to an anode (e.g., anode 112) and a cathode (e.g., cathode 114) of a battery component (e.g., battery component 100), respectively, to receive battery power from the flexible battery component. In FIG. 1B, the anode connector 192 and a cathode connector 194 are connected to the anode 112 and the cathode 114, respectively, to receive battery power from the electrolyte 110 of the flexible battery component 100. Although the example diagram of FIG. 1B shows that the device component 180 is coupled to the flexible battery component 100, the device component 180 may be separated from the flexible battery component 100.

The device component 180 may include a processor 182 configured to perform various tasks. In an aspect, the battery power from the electrolyte 110 may be provided to the processor 182 to provide power to the processor 182. The processor 182 may be configured to generate the control signal by executing instructions (e.g., stored in memory 145). The processor 182 may, in an embodiment, be implemented as one or more processors (e.g., a microprocessor), a field programmable gate array (FPGA), application specific integrated circuit (ASIC), programmable logic array (PLA), or other control circuit. The processor 182 may be part of a general purpose control circuit for the flexible battery component 100 or the processor 182 may be a processor dedicated to controlling haptic effects for the flexible battery component 100. In an aspect, the processor 182 may be a flexible processor, e.g., based on flexible thin-film transistor(s), such that the processor 182 may deform along with the flexible battery component 100 when the haptic component causes the deformation.

In an embodiment, the device component 180 may include a memory 184, as a data storage component. The memory 184 may be a flexible memory. In an embodiment, the memory 184 may be a non-transitory computer-readable medium, and may include read-only memory (ROM), random access memory (RAM), a solid state drive (SSD), a hard drive, a flash memory, or other type of memory. In FIG. 1B, the memory 184 may store instructions that can be executed by the processor 182 to generate a control signal, such as a trigger signal, as a trigger for the haptic feedback according to an embodiment described herein. In an embodiment, the memory 184 may store other information and/or modules.

In an embodiment, the device component 180 may include a display device 186. The processor 182 may communicate with the display device 186 to display data such as an image or video on the display device 186.

In an embodiment, the haptic component of the flexible battery component may include one or more haptic components, where the one or more haptic components are located in one or more haptic areas of the flexible battery component, respectively. In such an embodiment, the one or more haptic areas may correspond to one or more user interaction components of a device that may be coupled to the flexible battery component 100, where the one or more user interaction components are areas on the device with which the user may interact. For example, a haptic effect in each haptic area may be provided by a respective haptic component of the one or more haptic components. The one or more haptic areas may respectively correspond to one or more user interaction components on another component, such as the device component 180, that is configured to couple with the flexible battery component. In one example, when a user interaction component 188 of the device component 180 senses user interaction, a haptic component for a particular haptic area that corresponds to the user interaction component 188 sensing the user interaction may provide a haptic effect. As such, the user may perceive a haptic effect in an area corresponding to the user interaction component 188 of the device component 180 as the user interacts with the user interaction component 188. In one example, the one or more user interaction components 188 may be buttons for executing specific function, where the locations of the buttons may respectively correspond to the one or more haptic areas.

In one use example, the device component 180 may be a smart watch and the flexible battery component 100 may be implemented as a strap for the watch. When the smart watch receives a notification, the smart watch may cause the haptic component of the strap to deform, causing deformation of the strap that may be perceived by a user. In another use example, the haptic component of the flexible battery component 100 may undergo deformation according to an image or video displayed on the display device 186. In another use example, if the display device 186 is a touchscreen display, the haptic component of the flexible battery component 100 may undergo deformation when the user touches the touchscreen display of the display device 186.

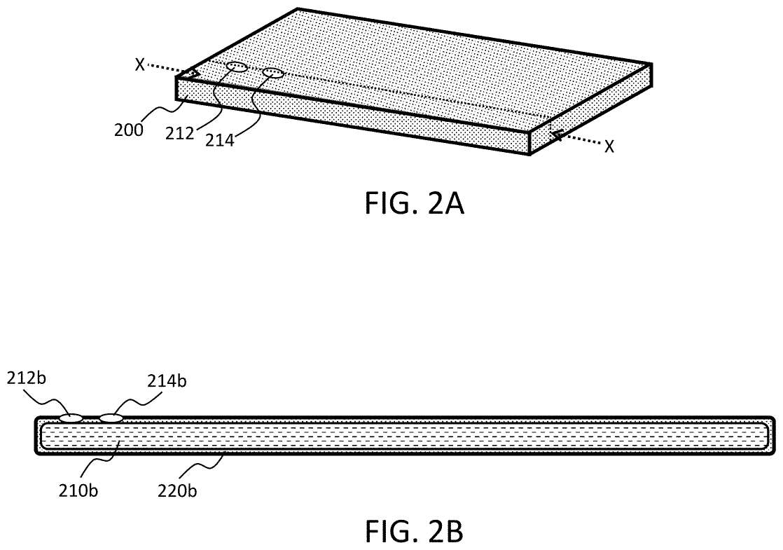

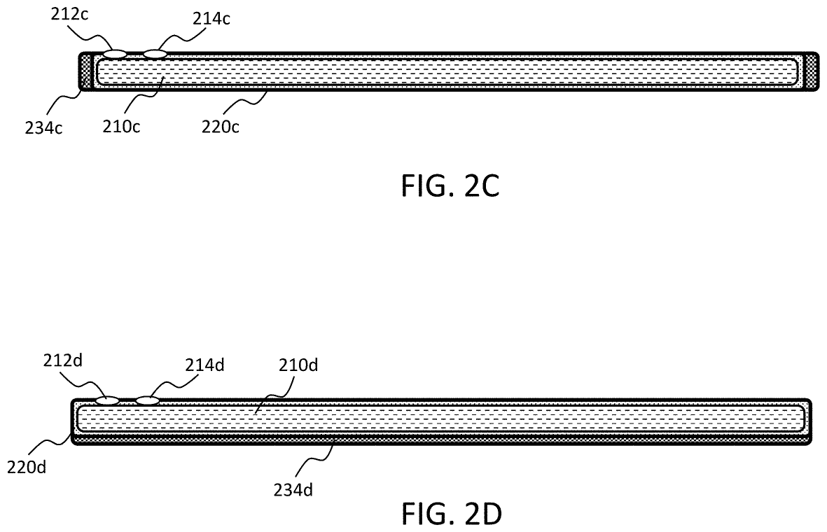

FIG. 2A is an example diagram illustrating a perspective view of a flexible battery component 200, according to an embodiment described herein. FIGS. 2B-2D are exemplary sectional views of the flexible battery component 200 along line X-X of FIG. 2A, according to various embodiments described herein. The flexible battery component 200 may be an example of the flexible battery component 100 of FIGS. 1A and 1B and thus may include all or some of the features of the flexible battery component 100. As shown in FIG. 2A, the flexible battery component 200 includes an anode 212 and a cathode 214 that are coupled to an electrolyte (not shown). The anode 212 and the cathode 214 are exposed to the outside of the flexible battery component 200, such that the anode 212 and the cathode 214 may be coupled to a device to provide battery power.

FIG. 2B is a sectional view of the flexible battery component 200, according to an embodiment described herein. According to the embodiment of FIG. 2B, the flexible battery component 200 may have an anode 212b and a cathode 214b that are connected to electrolyte 210b that is held within a container 220b. The anode 212b and the cathode 214b correspond to the anode 212 and the cathode 214 of FIG. 2A. In FIG. 2B, the flexible battery component 200 may include a haptic component (e.g., corresponding to the haptic component 130) that may be disposed within the electrolyte 210b and/or a haptic component (e.g., corresponding to the haptic component 132) disposed within the container 220b. The haptic component within the electrolyte 210b may be a haptic material mixed with the electrolyte 210b and/or may be disposed within the electrolyte 210b without being mixed with the electrolyte 210b. In an aspect, the container 220b may include a haptic component (e.g., haptic component 132). In an example, the container 220b itself may be a haptic component made of a haptic material. In an example, the container 220b may include a separate haptic component within the container 220b.

In an aspect, the flexible battery component 200 may include a haptic component disposed outside of a container of the flexible battery component 200, e.g., as shown in FIGS. 2C and 2D. FIG. 2C is a sectional view of the flexible battery component 200, according to an embodiment described herein. According to the embodiment of FIG. 2C, the flexible battery component 200 may have an anode 212c and a cathode 214c that are coupled to electrolyte 210c that is included within a container 220c. The anode 212c and the cathode 214c correspond to the anode 212 and the cathode 214 of FIG. 2A. FIG. 2C shows that a haptic component 234c is disposed outside of the container 220c. For example, the haptic component 234c is disposed at a side perimeter of the container 220c.

FIG. 2D is a sectional view of the flexible battery component 200, according to an embodiment described herein. According to the embodiment of FIG. 2D, the flexible battery component 200 may have an anode 212d and a cathode 214d that are coupled (e.g., connected) to electrolyte 210d that is included (e.g., contained) within a container 220d. The anode 212d and the cathode 214d correspond to the anode 212 and the cathode 214 of FIG. 2A. FIG. 2D shows that a haptic component 234d is disposed outside of the container 220d. In particular, the haptic component 234d is disposed against a planar surface of the container 220d.

FIGS. 2A-2D show various example embodiments of the flexible battery component 100 of FIG. 1A. Thus, in FIGS. 2A-2D, the anode 212/212b/212c/212d, the cathode 214/214b/214c/214d, the electrolyte 210b/210c/210d, and the container 220b/220c/220d may be examples of the anode 112, the cathode 114, the electrolyte 110, and the container 120 of FIG. 1A, respectively.

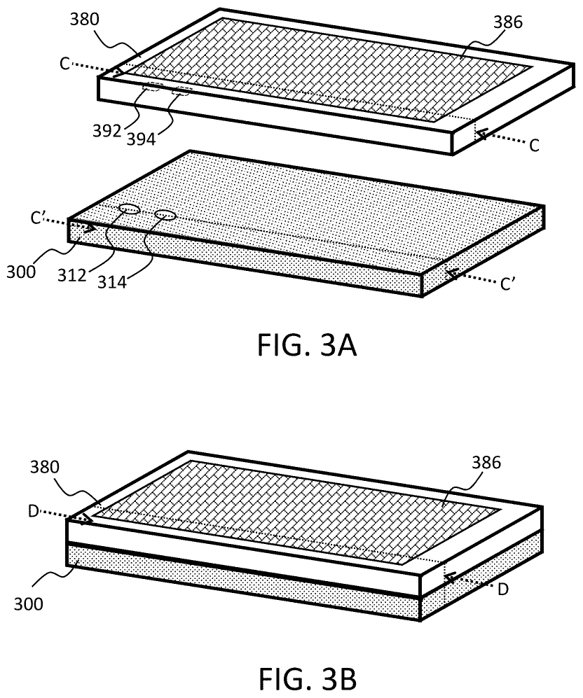

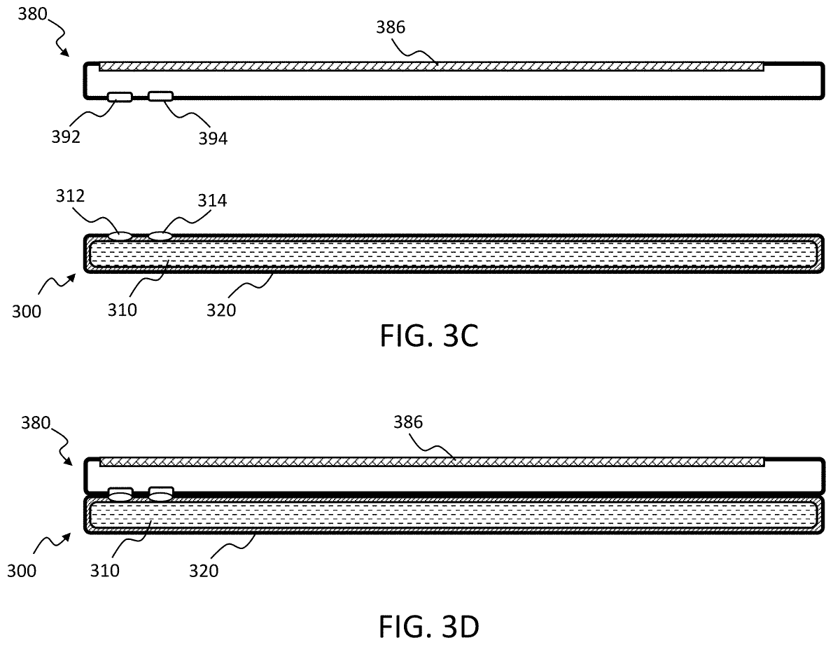

FIGS. 3A and 3B illustrate a flexible device including a flexible battery component, and a device component configured to couple with the flexible battery component, according to an embodiment described herein. FIG. 3A depicts a perspective view of a flexible battery component 300 and a device component 380 configured to couple with the flexible battery component 300 when the flexible battery component 300 is separated from the device component 380. FIG. 3B depicts a perspective view of the flexible battery component 300 coupled to the device component 380. The device component 380 may be an example of the device component 180 of FIG. 1B, and thus may include all or some of the features of the device component 180. The flexible battery component 300 may be an example of the flexible battery component 100 of FIGS. 1A and 1B and thus may include all or some of the features of the flexible battery component 100. The device component 380 may have a display device 386 to display data such as an image or video. As shown in FIGS. 3A and 3B, the flexible battery component 300 also includes an anode 312 and a cathode 314 that are coupled to an electrolyte (310 in FIGS. 3C and 3D) within the flexible battery component 300, where the anode 312 and the cathode 314 may be connected to an anode connector 392 and a cathode connector 394 of the device component 380 to provide battery power to the device component 380 when the flexible battery component 300 couples with the device component 380. Further, as shown in FIGS. 3A and 3B, the flexible device according to an embodiment described herein may be advantageous in that the flexible device has a simple structure with two layers (e.g., without housing), the layer of the device component and the layer of the flexible battery component capable providing battery power and haptic feedback.

FIG. 3C depicts sectional views of the flexible battery component 300 and the device component 380 being separated from each other, where the sectional views are taken across lines C-C and line C′-C′, respectively, of FIG. 3A. FIG. 3D depicts a sectional view of the flexible battery component 300 coupled to the device component 380, where the sectional view is taken across line D-D of FIG. 3B. As shown in FIG. 3D, when the flexible battery component 300 is coupled to the device component 380, the anode 312 and the cathode 314 are coupled (e.g. connected), for example, to the anode connector 392 and the cathode connector 394, respectively, to draw battery power from the electrolyte 310 to the device component 380.

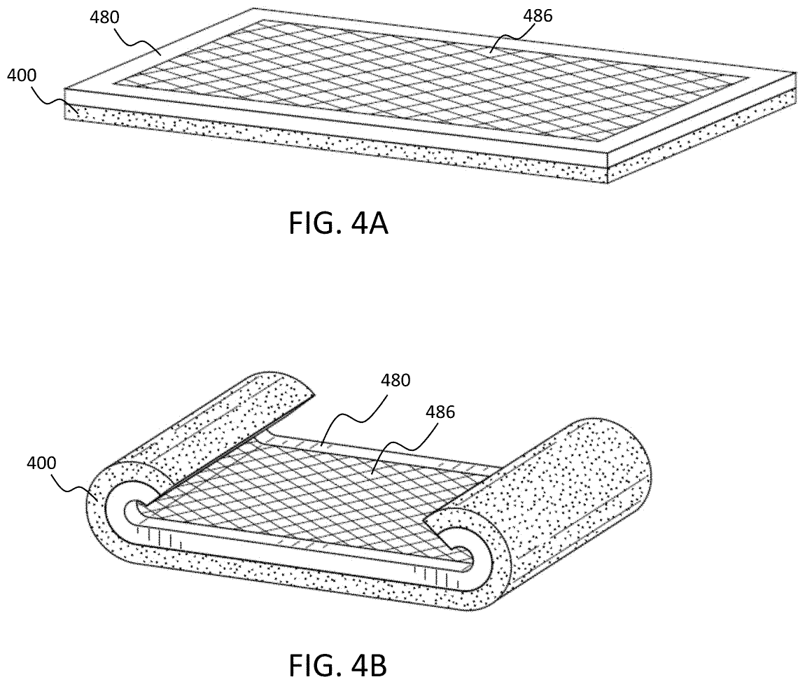

FIGS. 4A and 4B depict a flexible battery component 400 for providing a haptic effect, according to an embodiment described herein. FIG. 4A depicts a flexible battery component 400 that is in a normal state where the flexible battery component 400 is not providing a haptic effect. The flexible battery component 400 may be an example of the flexible battery component 100/200/300. The flexible battery component 400 may include a haptic component that may undergo deformation to provide a haptic effect, thereby causing deformation of the flexible battery component 400. As discussed above, for example, the haptic component may undergo deformation when a trigger is applied to the haptic component.

A device component 480 may be coupled to the flexible battery component 400. The device component 480 may be flexible, so as to deform with the flexible battery component 400 when the flexible battery component 400 deforms. As shown in FIG. 4A, during the normal state, the flexible battery component 400 does not undergo deformation, and thus may not cause the device component 480 to deform.

FIG. 4B depicts the flexible battery component 400 in a haptified state, where the flexible battery component 400 is deformed. In the example of FIG. 4B, the haptic component of the flexible battery component 400 undergoes deformation to provide a haptic effect, thereby causing the flexible battery component 400 to change shape or otherwise deform (such as twist, wrinkle, bend, curl, etc.). As the flexible battery component 400 deforms, the device component 480 coupled to the flexible battery component 400 may change shape or otherwise deform (such as twist, wrinkle, bend, curl, etc.) with the flexible battery component 400.

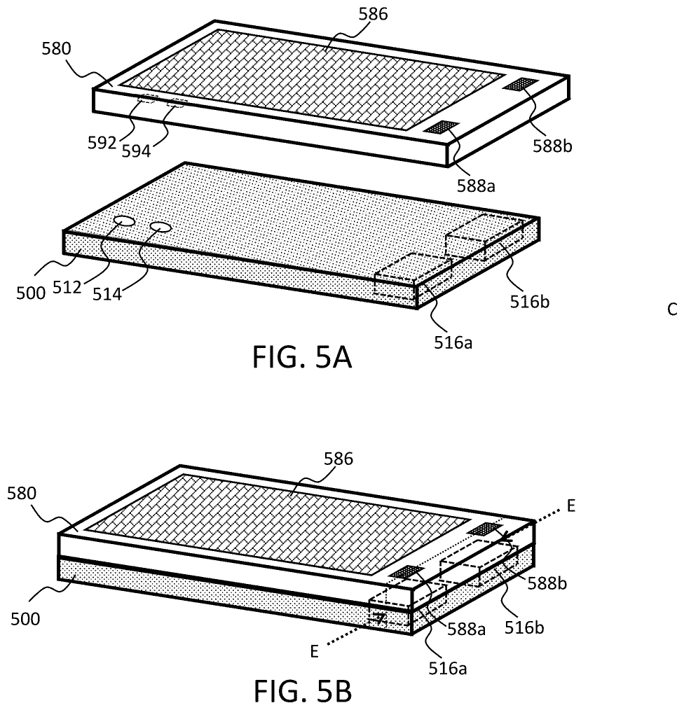

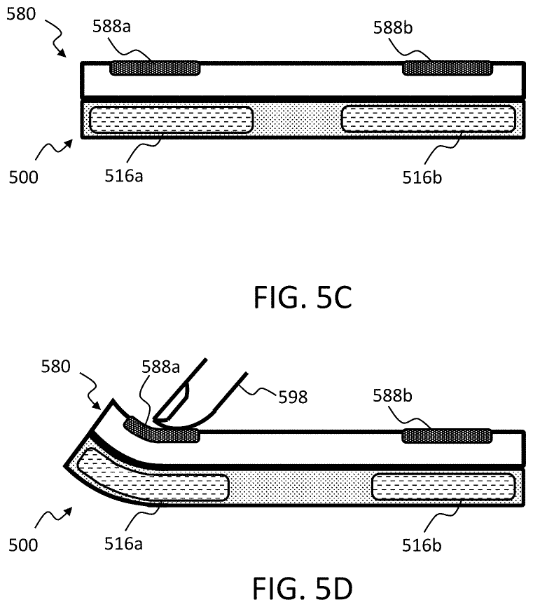

In an embodiment, as discussed above, the flexible battery component 100/300/400 may include one or more haptic components having haptic areas that respectively correspond to one or more user activation areas of another component, such as the device component 180/380/480. FIGS. 5A-5B depict a flexible battery component including haptic components having haptic areas and a device component including user interaction components, according to an embodiment described herein, where the haptic areas of the flexible battery component respectively correspond to the user interaction components of the device component. FIG. 5A depicts a perspective view of a flexible battery component 500 separated from a device component 580, with the flexible battery component 500 having haptic components 516a, 516b and the device component 580 having user interaction components 588a, 588b. FIG. 5B depicts a perspective view of the flexible battery component 500 coupled to the device component 580. The haptic components 516a, 516b may have or be associated with haptic areas to provide haptic effects. For example, the haptic areas associated with the haptic component 516a, 516b may be portions of the flexible battery component surrounding the haptic components 516a, 516b. The haptic areas of the haptic components 516a, 516b respectively correspond to the user interaction components 588a, 588b when the flexible battery component 500 is coupled with the device component 580, as shown in FIG. 5B. For example, when a user interacts with the user interaction component 588a, the haptic component 516a may provide a haptic effect to the haptic area corresponding to the user interaction component 588a. Similarly, for example, when a user interacts with the user interaction component 588b, the haptic component 516b may provide a haptic effect to the haptic area corresponding to the user interaction component 588b. In the example shown in FIGS. 5A and 5B, the user interaction components 588a, 588b may be touch buttons having respective functionalities that may be activated by user touch. Further, as shown in FIGS. 5A and 5B, the flexible battery component 500 also includes an anode 512 and a cathode 514 that are coupled to an electrolyte within the flexible battery component 500, where the anode 512 and the cathode 514 may be coupled (e.g., connected) to, for example, an anode connector 592 and a cathode connector 594 of the device component 580 to provide battery power to the device component 580 when the flexible battery component 500 couples with the device component 580.

FIG. 5C depicts a cross-sectional view of the flexible battery component 500 coupled to the device component 580, according to an embodiment described herein, where the haptic components 516a, 516b are not activated. The cross-sectional view is taken across the line E-E of FIG. 5B. In FIG. 5C, the haptic components 516a, 516b are not activated and thus do not provide haptic effects, for example, because there is no user interaction with the user interaction components 588a, 588b.

FIG. 5D depicts a cross-sectional view of the flexible battery component 500 coupled to the device component 580, according to an embodiment described herein, where the haptic component 516a is activated. When a finger of the user touches or otherwise couples to the user interaction component 588a, for example, a signal is sent from the user interaction component 588a to cause the haptic component 516a to provide a haptic effect by deformation (e.g., bending). As such, simultaneous haptic feedback may be provided to the user as the user uses the device component 580 by interacting with the user interaction component 588a.

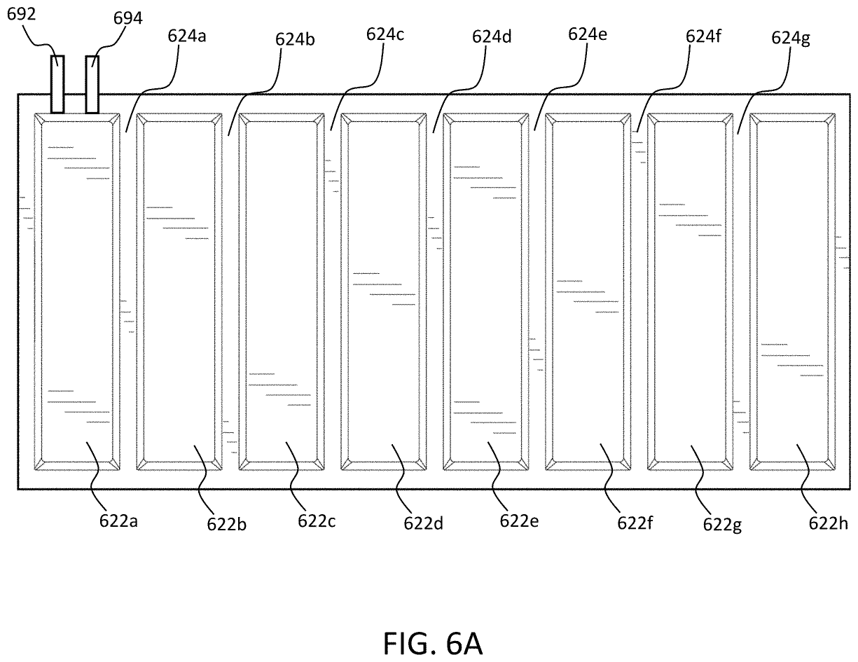

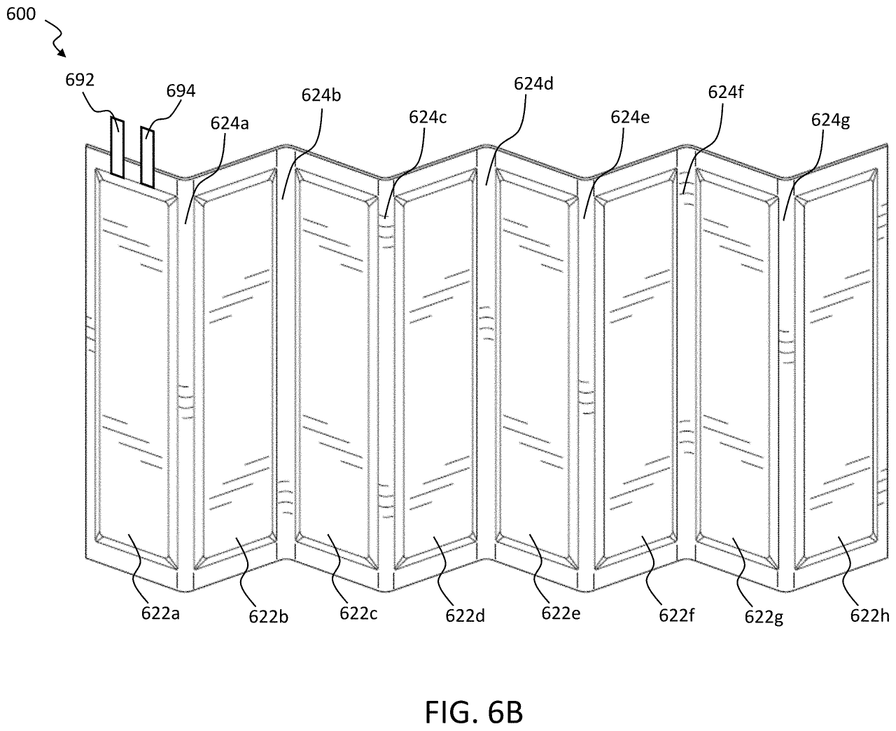

As discussed above, a container 120 of the flexible battery component 100 may include multiple compartments that include (e.g., contain) the electrolyte 110. FIG. 6A is an example diagram illustrating a flexible battery component 600 having a container 620 that includes multiple compartments that include (e.g., contain) an electrolyte, according to an embodiment hereof. As shown in FIG. 6A, the multiple compartments 622a-622h of the container 620 include the electrolyte, and an anode 692 and a cathode 694 are coupled (e.g., connected) to the electrolyte. The container 620 may be deformable in the portions surrounding the multiple compartments 622a-622h, regardless of whether the electrolyte is flexible or deformable. In one example, the container 620 may be deformable in connector portions 624a-624g between the compartments 622a-622h. Hence, a haptic component may be disposed in the portions surrounding the multiple components 622a-622h, such that the haptic component may provide a haptic effect by deforming the portions surrounding the multiple components 622a-622h.

FIG. 6B is an example diagram illustrating the flexible battery component 600 undergoing deformation as a haptic effect, according to an embodiment described herein. As shown in FIG. 6B, in one example, the haptic component of the flexible battery component 600 provides a haptic effect by deforming the connector portions 624a-624g between the multiple components 622a-622h.

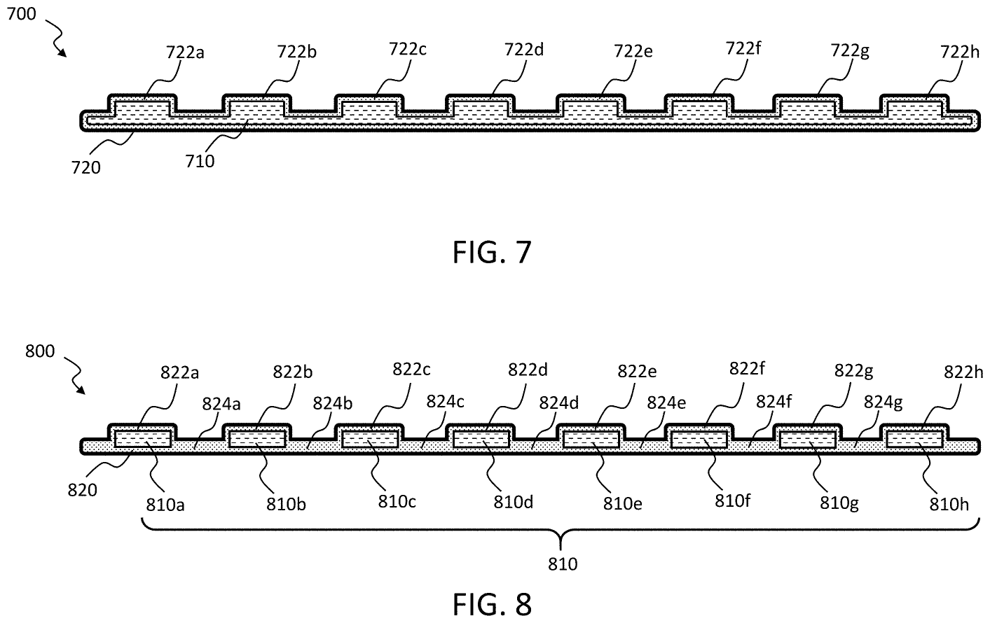

FIG. 7 depicts a sectional view of a flexible battery component 700 with a container having multiple compartments, according to an embodiment hereof. The sectional view of FIG. 7 may be a sectional view of the flexible battery component 600 of FIG. 6A, according to an embodiment. The flexible battery component 700 has a container 720 having multiple compartments 722a-722h, where adjacent compartments of the compartments 722a-722h are coupled (e.g., connected) to each other within the container 720. An electrolyte 710 may be included in the container 720. In the example illustrated in FIG. 7, a greater volume of electrolyte 710 may be included in the compartments 722a-722h of the container 720 than in other connector portions of the container 720.

FIG. 8 depicts a sectional view of a flexible battery component 800 with a container having multiple, separated compartments, according to an embodiment hereof. The sectional view of FIG. 8 may be a sectional view of the flexible battery component 600 of FIG. 6A, according to an embodiment. The flexible battery component 800 has a container 820 having multiple compartments 822a-822h that are separated from one another. An electrolyte 810 may be included in the container 820. In particular, the electrolyte 810 includes multiple electrolyte portions 810a-810h that are respectively included in the compartments 822a-822h of the container 820. Because the compartments 822a-822h are separated from one another, even if the electrolyte 810 is not flexible or deformable, a haptic component within the container 820 may still deform at connector portions 824a-824g of the container 820 between the compartments 822a-822h, as shown in FIG. 8.

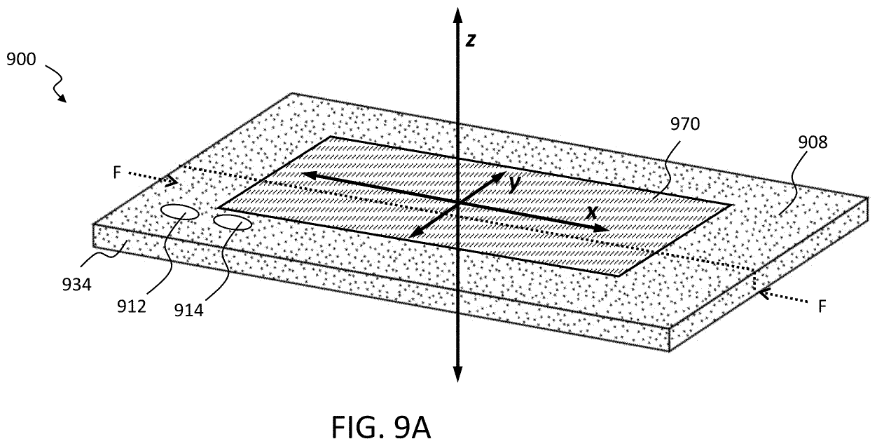

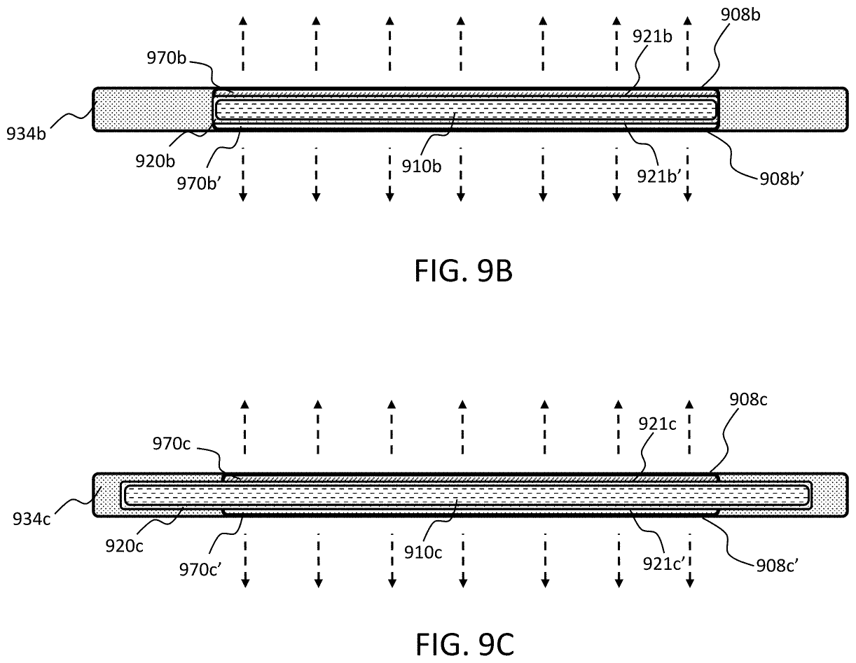

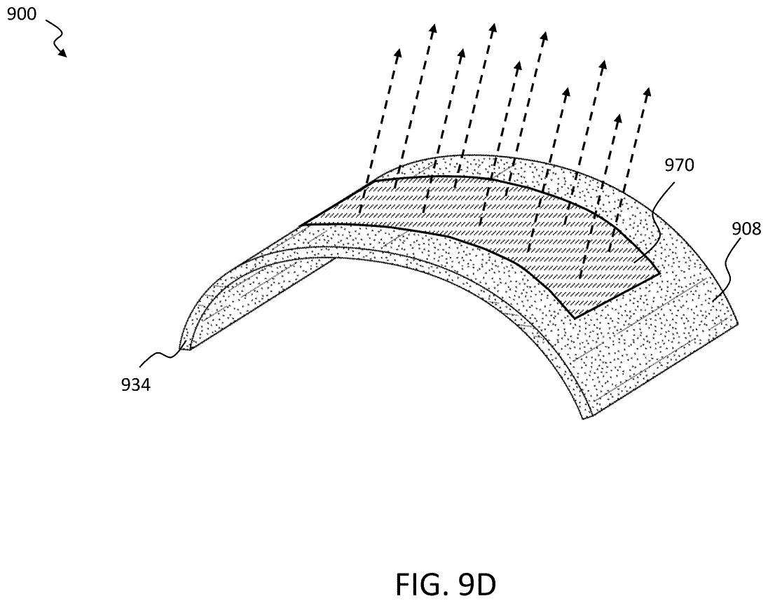

FIG. 9A depicts a structure of a flexible battery component 900 to direct heat dissipation to a particular direction, according to an embodiment described herein. FIGS. 9B and 9C are alternative sectional views of the flexible battery component 900 along line F-F of FIG. 9A, according to various embodiments hereof. The flexible battery component 900 includes an anode 912 and a cathode 914 coupled (e.g., connected) to an electrolyte of the flexible battery component 900. The flexible battery component 900 includes a haptic component 934, which is formed of a shape memory material in order to change shape/deform to provide a haptic effect, and a heat dissipation structure 970, which provides a heat dissipation path for heat experienced by the flexible battery component 900. The heat dissipation path is in a z-axis direction that is perpendicular, substantially perpendicular, or out-of-plane with respect to a planar surface 908 of the flexible battery component 900, rather than in an in-plane direction, such as along a y-axis or x-axis, for instance, of the planar surface 908 of the flexible battery component 900. In an example, a material of the heat dissipation structure 970 may have a high thermal conductivity, e.g., a high coefficient of thermal conductivity, relative to a material of the haptic component 934 to effectively draw heat away from the haptic component 934. For example, the material of the heat dissipation structure 970 with a high thermal conductivity may be copper having a thermal conductivity of 400 W·m⁻¹·K⁻¹, and the material of the haptic component 934 may be fiberglass or foam-glass having a thermal conductivity of 0.4 W·m⁻¹·K⁻¹.

FIG. 9B depicts a sectional view of the battery component 900 along line F-F of FIG. 9A according to an embodiment thereof. In the embodiment of FIG. 9B, the flexible battery component 900 includes an electrolyte 910b and a container 920b including the electrolyte 910b disposed within the flexible battery component 900. The flexible battery component 900 includes a haptic component 934b surrounding a perimeter of the container 920b and the electrolyte 910b, such that the haptic component 934b defines a frame or border portion of the flexible battery component 900. The flexible battery component 900 further includes heat dissipation structures 970b, 970b′ adjacent opposing planar surfaces 921b, 921b′ of the container 920b, such that the heat dissipation structures 970b, 970b′ define central exterior portions of the flexible battery component 900. As such, for example, the heat dissipation structures 970b, 970b′ may dissipate heat generated by the flexible battery component 900. More particularly, in the embodiment of FIG. 9B, the location of the heat dissipation structures 970b, 970b′ corresponds to the location of the electrolyte 910b, which may be a heat source. For example, as shown in FIG. 9B, heat dissipation paths indicated by dashed arrows are perpendicular, substantially perpendicular, or out-of-plane with respect to opposing planar surfaces 908b, 908b′ of the flexible battery component 900. In an example, the heat dissipation paths may be perceived as being perpendicular, substantially perpendicular, or out-of-plane with respect to planar surfaces of the heat dissipation structures 970b, 970b′. In addition, the heat dissipation structures 970b, 970b′ may be configured to have little or no heat dissipation along a plane defined by the x-axis and the y-axis, which are in-plane directions of the flexible battery component 900. Although two heat dissipation structures 970b, 970b′ are shown the embodiment of FIG. 9B, only one heat dissipation structure may be used in other embodiments described herein without departing from the scope of the present invention.

FIG. 9C depicts a sectional view of the battery component 900 along line F-F of FIG. 9A according to an embodiment thereof. In the embodiment of FIG. 9C, the flexible battery component 900 includes an electrolyte 910c and a container 920c including the electrolyte 910c disposed within the flexible battery component 900. The flexible battery component 900 includes a haptic component 934c surrounding a perimeter of the container 920c and the electrolyte 910c. The flexible battery component 900 further includes heat dissipation structures 970c, 970c′ on adjacent opposing surfaces of the container 920c. As such, for example, the heat dissipation structure 970c, 970c′ may dissipate heat generated by the battery component 900. In the embodiment of FIG. 9C, the heat dissipation structures 970c, 970c′ do not entirely cover the opposing surfaces 921c, 921c′ of the container 920c with the electrolyte 910b, which may be a heat source. In one example, a thermal conductivity of the heat dissipation structures 970c, 970c′ may be greater than a thermal conductivity of the haptic component 934c, such that heat from the electrolyte 910c may be effectively drawn to the heat dissipation structures 970c, 970c′ although the heat dissipation structures 970c, 970c′ do not entirely cover the opposing surfaces 921c, 921c′ of the container 920c. For example, as shown in FIG. 9C, heat dissipation paths indicated by dashed arrows are perpendicular, substantially perpendicular, or out-of-plane with respect to planar surfaces 908c, 908c′ of the flexible battery component 900. In an example, the heat dissipation paths may be perceived as being perpendicular or out-of-plane with respect to the planar surfaces of the heat dissipation structure 970c, 970c′. In addition, the heat dissipation structures 970c, 970c′ may be configured to have little or no heat dissipation along a plane defined by the x-axis and the y-axis, which are in-plane directions of the flexible battery component 900. Although two heat dissipation structures 970c, 970c′ are shown the embodiment of FIG. 9C, only one heat dissipation structure may be used in other embodiments described herein without departing from the scope of the present invention.

FIG. 9D depicts heat dissipation of the flexible battery component 900 during a change in shape/deformation of the flexible battery component 900, according to embodiments described herein. If heat from the battery component 900 or other external heat increases a temperature in the haptic component 934 formed of the shape memory material, the haptic component 934 may deform even in the absence of the trigger, which creates unwanted deformation in the haptic component 934 and the flexible battery component 900 as a whole. For example, in FIG. 9D, the shape-changing haptic component 934 may undesirably transition to its “remembered” shape due to heat generated by the battery component 900. With the heat dissipation structure 970, the heat that may cause such unwanted deformation of the flexible battery component 900 may be dissipated in directions perpendicular or out-of-plane with respect to the planar surface of the flexible battery component 900 such that the flexible battery component 900 only deform as shown in FIG. 9D when a trigger is actually applied and such deformation is intended. In FIG. 9D, arrows are shown that indicate heat dissipation in directions perpendicular, substantially perpendicular, or out-of-plane with respect to the planar surface 908 of the flexible battery component 900.

While various embodiments have been described above, it should be understood that they have been presented only as illustrations and examples of the present invention, and not by way of limitation. It will be apparent to persons skilled in the relevant art that various changes in form and detail can be made thereof without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A flexible battery component providing multiple functions, the flexible battery component comprising:
an anode;
a cathode;
an electrolyte coupled to the cathode and the anode and configured to provide electrical power via the anode and the cathode;
a container including the electrolyte and configured to be flexible and deformable; and
at least one haptic component configured to provide a haptic effect, the at least one haptic component being included in at least one of the electrolyte or the container.

2. The flexible battery component of claim 1, wherein the at least one haptic component is configured to provide the haptic effect based on at least one of an electrical signal, an electric field, a magnetic field, a lighting condition, a pH level, or a temperature.

3. The flexible battery component of claim 1, wherein the electrolyte includes at least one of a liquid electrolyte, a semi-solid electrolyte, or a solid electrolyte.

4. The flexible battery component of claim 1, wherein the container includes a plurality of compartments, and the electrolyte is included in the plurality of compartments.

5. The flexible battery component of claim 1, wherein the at least one haptic component includes one or more haptic components located in one or more haptic areas of the flexible battery component, respectively.

6. The flexible battery component of claim 5, wherein the one or more haptic areas respectively correspond to one or more user interaction components on another component configured to be coupled with the flexible battery component.

7. The flexible battery component of claim 1, wherein the at least one haptic component is formed of a shape memory material and is configured to provide the haptic effect by a change in a shape thereof.

8. The flexible battery component of claim 7, wherein the at least one haptic component is coupled to at least a perimeter of the container.

9. The flexible battery component of claim 7, wherein the change in shape of the at least one haptic component is triggered by at least one of an electrical signal, an electric field, a magnetic field, a lighting condition, a pH level, or a temperature.

10. The flexible battery component of claim 7, wherein the at least one haptic component further includes a plurality of magnetically-activated particles configured to generate heat when a magnetic field is applied to the magnetically-activated particles, and the at least one haptic component is configured to change shape based on the heat generated by the plurality of magnetically-activated particles.

11. The flexible battery component of claim 7, wherein the flexible battery component further comprises a heat dissipation structure to provide a heat dissipation path for the at least one haptic component in a direction perpendicular to a planar surface of the flexible battery component.

12. The flexible battery component of claim 11, wherein the heat dissipation structure reduces or prevents heat dissipation in an in-plane direction of the planar surface.

13. The flexible battery component of claim 1, further comprising a processor configured to provide a haptic signal to the at least one haptic component to provide the haptic effect based on the haptic signal.

14. The flexible battery component of claim 1, wherein the electrolyte includes the at least one haptic component.

15. The flexible battery component of claim 1, wherein the at least one haptic component includes a gel material configured to change viscosity based on at least one of an electrical signal, magnetic field, a lighting condition, a pH level, or a temperature.

16. The flexible battery component of claim 1, further comprising at least one of a power-harvesting component configured to harvest power from an environment of the flexible battery component or a sensor.

17. A flexible device comprising:
a flexible battery component for providing multiple functions, the flexible battery component comprising,
an anode,
a cathode,
an electrolyte coupled to the cathode and the anode and configured to provide electrical power via the anode and the cathode,
a container including the electrolyte and configured to be flexible and deformable, and
at least one haptic component configured to provide a haptic effect based on at least one of a haptic signal or an environment factor applied to the at least one haptic component, the at least one haptic component being included in at least one of the electrolyte or the container; and
a device component including at least one processor coupled to and powered by the flexible battery component.

18. The flexible device of claim 17, wherein the device component further comprises a flexible display device coupled to and powered by the flexible battery component.

19. The flexible device of claim 17, wherein the at least one haptic component includes one or more haptic components located in one or more haptic areas of the flexible battery component, respectively, and
wherein the flexible device includes one or more user interaction components that respectively correspond with the one or more haptic areas.

20. The flexible device of claim 17, wherein the at least one haptic component is formed of a shape memory material and is configured to provide the haptic effect by a change in a shape thereof, and
wherein the change in the shape of the at least one haptic component causes a change in a shape of the device component.
